(19) United States
(12) Patent Application Publication
(10) Pub. No.: US 2019/0295161 A1
(43) Pub. Date: Sep. 26, 2019

(54) COMPUTER SYSTEM, AND METHOD AND PROGRAM FOR SETTLEMENT

(71) Applicant: OPTIM Corporation, Saga-shi (JP)

(72) Inventor: Shunji SUGAYA, Tokyo (JP)

(21) Appl. No.: 15/566,760

(22) PCT Filed: Dec. 19, 2016
(86) PCT No.: PCT/JP2016/087847

§ 371 Date: Oct. 16, 2017

(51) Int. Cl. G06Q 40/02

(52) U.S. Cl. CPC G06Q 40/025; G06F 16/2282

(57) ABSTRACT

The present invention is to provide a computer system, and a method and a program for settlement that are capable to restrict the place where the settlement of business expenses can be made and to gain approval of the settlement according to workflow. The computer system checks whether or not the current location of a terminal is previously registered; and restricts the terminal from performing a purchase settlement process if the current location of the terminal is not previously registered. Moreover, the computer system receives a credit-card settlement request associated with an approval flow in which an approver makes credit-card settlement, suspends the settlement without making the settlement even if the receiving unit receives the settlement request, requests an approver in the approval flow to approve the settlement, and makes the settlement suspended by the suspending unit on approval from the approver.

### TECHNICAL FIELD

The present invention relates to a computer system, and a method and a program for settlement.

### BACKGROUND ART

Recently, the business system that is called a workflow system to do business on a computer according to a work manual appeared. The workflow system defines work flow for a particular job and repeatedly notifies the following worker on the completion of a work to perform all the tasks of the job. For example, a drafter (staff) prepares and submits a document to the immediate superior (section chief or who primarily makes settlement) when desiring to pay for office supplies, travel expenses, and accommodation fees on business with a credit card. The superior receives a notification of settlement application from a workflow system and makes settlement. Then, another supervisor (division chief or who secondarily makes settlement receives a notification of the settlement application from a workflow system and makes the settlement. These tasks repeat until the settlement is finally made. When the settlement is finally made, the drafter (staff) receives the notification that the settlement has been approved. Then, the drafter (staff) can pay for the expenses with a credit card (for example, refer to Patent Document 1).

### CITATION LIST

### Patent Literature

Patent Document 1: JP 2015-230581 A

### SUMMARY OF INVENTION

However, in the conventional systems, the drafter (staff) often pays for office supplies, travel expenses, and accommodation fees on business by using the terminal that the drafter owns without approval from the superiors. This causes a company problem.

In view of such demand, an objective of the present invention is to provide a computer system, and a method and a program for settlement that are capable to restrict the place where the settlement of business expenses can be made and to gain approval of the settlement according to workflow.

The present invention provides a computer system including:

a check unit that checks whether or not the current location of a terminal is previously registered; and

a purchase restriction unit that restricts the terminal from performing a purchase settlement process if the current location of the terminal is not previously registered.

According to the present invention, the computer system checks whether or not the current location of a terminal is previously registered; and restricts the terminal from performing a purchase settlement process if the current location of the terminal is not previously registered.

The present invention is the category of a computer system, but the categories of a method, a program, etc., for settlement have similar functions and effects.

The present invention can provide a computer system, and a method and a program for settlement that are capable to restrict the place where the settlement of business expenses can be made and to gain approval of the settlement according to workflow.

### BRIEF DESCRIPTION OF DRAWINGS

FIG. 1 shows a block diagram illustrating a hardware configuration and a software function of the system for credit-card settlement with approval flow 1 in an embodiment.

FIG. 2 shows a flow chart illustrating a method of credit-card settlement with approval flow in the embodiment.

FIG. 3 shows one example of the ID management table 41 stored in the memory unit 40 of the purchase web server 10 in the system for credit-card settlement with approval flow 1.

FIG. 4 shows one example of the settlement application data 42 stored in the memory unit 40.

FIG. 5 shows one example of the credit card information table 43 stored in the memory unit 40.

FIG. 6 shows one example of the settlement completion table 44 stored in the memory unit 40.

FIG. 7 shows one example of the settlement approval data table 82 stored in the memory unit 80 of the workflow server 50 in the system for credit-card settlement with approval flow 1.

### DESCRIPTION OF EMBODIMENTS

Embodiments of the present invention will be described below with reference to the attached drawings. However, these are illustrative only, and the technological scope of the present invention is not limited thereto.

### Configuration of Settlement System 1 and Terminal 100

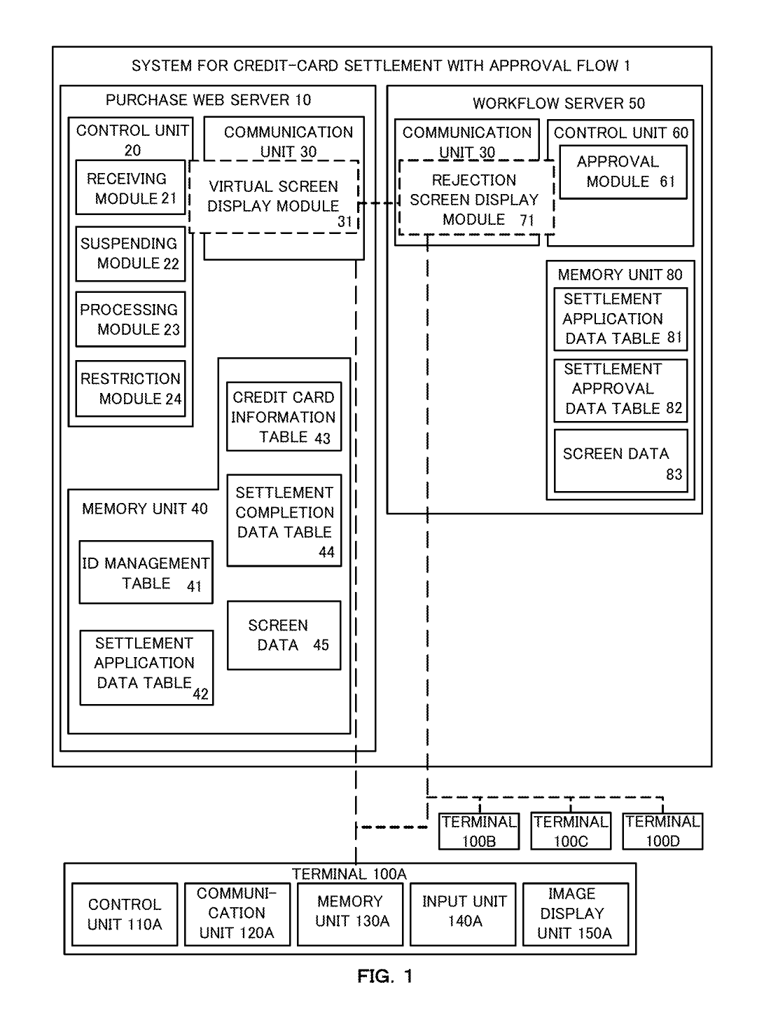

FIG. 1 shows a block diagram illustrating a hardware configuration and a software function of the settlement system 1 in an embodiment.

The settlement system 1 includes a purchase web server 10 that manages a purchase process through a credit card for office supplies, travel expenses, and accommodation fees on business and a workflow server 50 that manages the approval flow of settlement request from a drafter.

### Purchase Web Server 10

The purchase web server 10 at least includes a control unit 20 to control data, a communication unit 30 to communicate with other devices, and a memory unit 40 to store data.

The control unit 20 includes a central processing unit (hereinafter referred to as “CPU”), a random access memory (hereinafter referred to as “RAM”), and a read only memory (hereinafter referred to as “ROM”).

The communication unit 30 includes a device that is communicative to other devices, such as a Wireless Fidelity (Wi-Fi®) enabled device complying with, for example, IEEE 802.11.

The control unit 20 reads a predetermined program to achieve a receiving module 21, a suspending module 22, a processing module 23, and a restriction module 24.

Moreover, the control unit 20 reads a predetermined program to achieve a virtual screen display module 31 in cooperation with the communication unit 30.

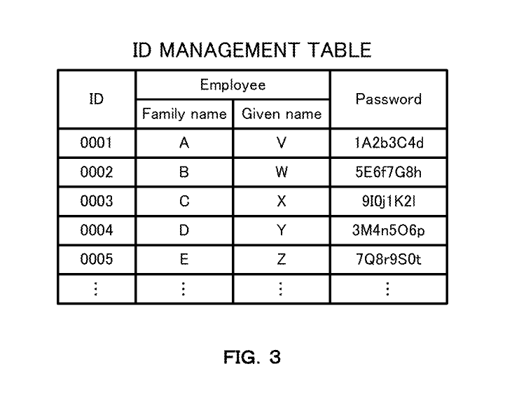

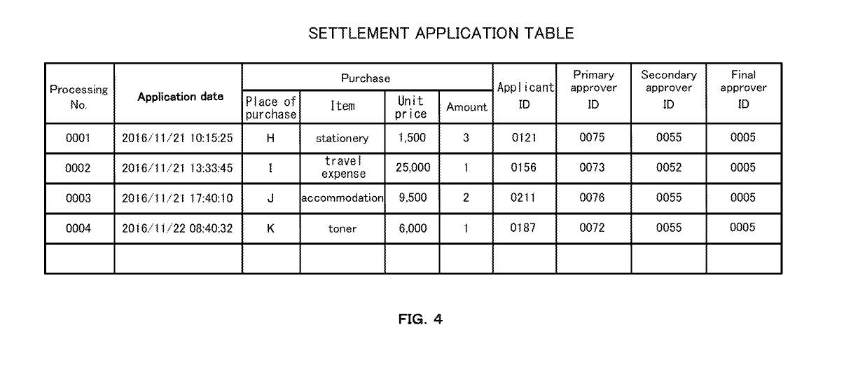

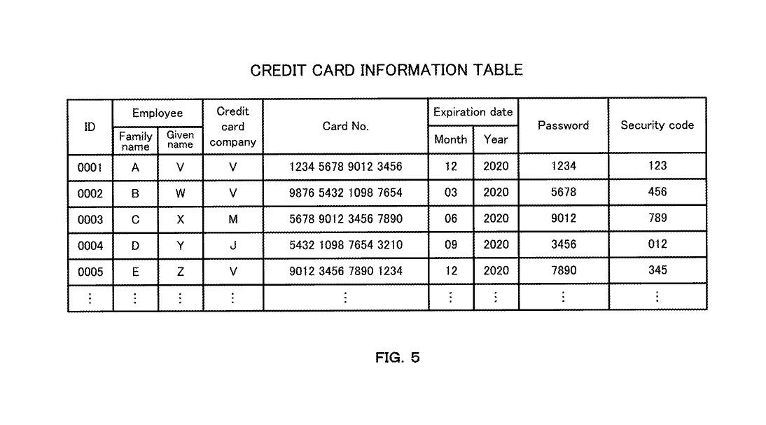

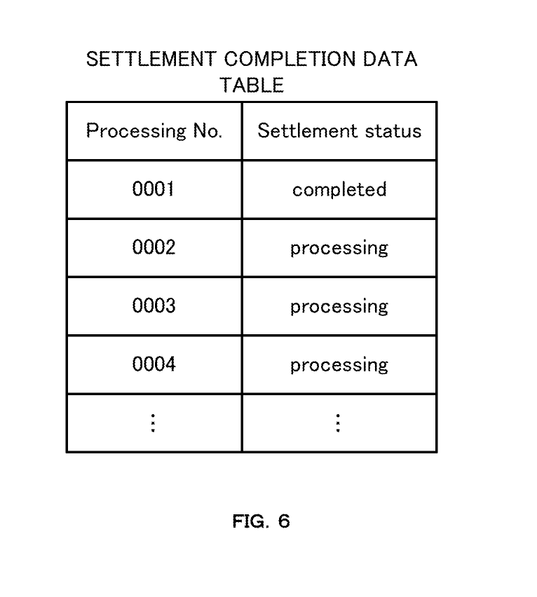

The memory unit 40 is to store data and files and includes a data storage unit such as a hard disk, a semiconductor memory, a record medium, or a memory card. The memory unit 40 stores the ID management table 41 (FIG. 3), the settlement application data table 42 (FIG. 4), the credit card information table 43 (FIG. 5), and the settlement completion data table 44 (FIG. 6) that are to be described later. The memory unit 40 also stores data on images (image data 45) to be displayed on the image display unit 150A of the terminal 100A.

### Workflow Server 50

The workflow server 50 at least includes a control unit 60 to control data, a communication unit 70 to communicate with other devices, and a memory unit 80 to store data.

The control unit 60 includes a CPU, a RAM, and a ROM in the same way as the control unit 20.

The communication unit 70 includes a device that is communicative with other devices in the same way as the communication unit 30.

The control unit 60 reads a predetermined program to achieve an approval module 61.

Moreover, the control unit 60 reads a predetermined program to achieve a rejection screen display module 71 in cooperation with the communication unit 70.

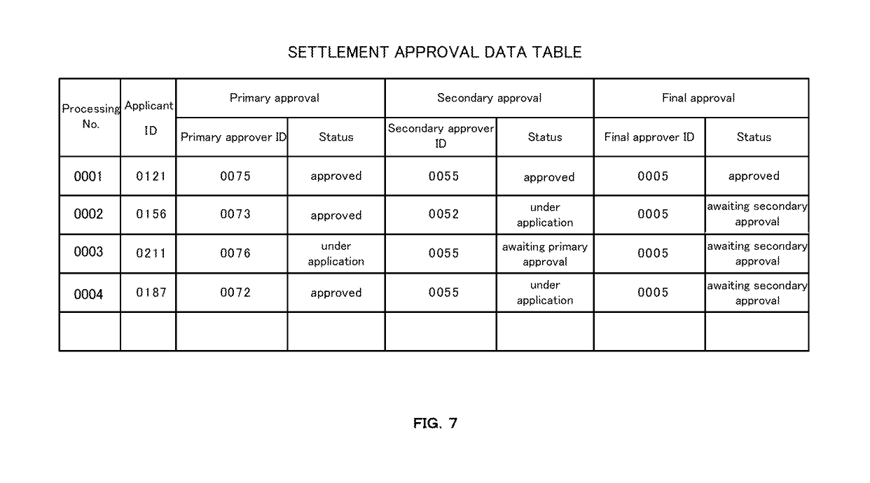

The memory unit 80 includes a data storage unit such as a hard disk, a semiconductor memory, a record medium, or a memory card in the same way as the memory unit 40. The memory unit 80 stores the settlement application data table 81 and the settlement approval data table 82 (FIG. 7) that are to be described later. The memory unit 80 also stores data on images (image data 83) to be displayed on the image display unit 150A of the terminal 100A.

### Terminal 100A

The purchase web server 10 and the workflow server 50 each are connected with the terminal 100A through a network.

The type of the terminal 100A is not limited in particular. Examples of the terminal 100A include computer devices such as a personal computer and a smart phone.

The terminal 100A at least includes a control unit 110A that controls data, a communication unit 120A that communicates with other devices, a memory unit 130A that stores data, an input unit 140A that receives operation from the user, and an image display unit 150A that outputs and displays the data and images controlled by the control unit 110A.

The control unit 110A includes a CPU, a RAM, and a ROM in the same way as the control unit 20, etc.

The communication unit 120A includes a device that is communicative with other devices in the same way as the communication unit 30, etc.

The memory unit 130A includes a data storage unit such as a hard disk, a semiconductor memory, a record medium, or a memory card in the same way as the memory unit 40, etc.

The type of the input unit 140A is not limited in particular. Examples of the input unit 140A include a keyboard, a mouse, and a touch panel.

The type of the image display unit 150A is not limited in particular. Examples of the image display unit 150A include a monitor and a touch panel.

Flow Chart Illustrating a Method of Credit-Card Settlement with Approval Flow that Uses the Settlement System 1

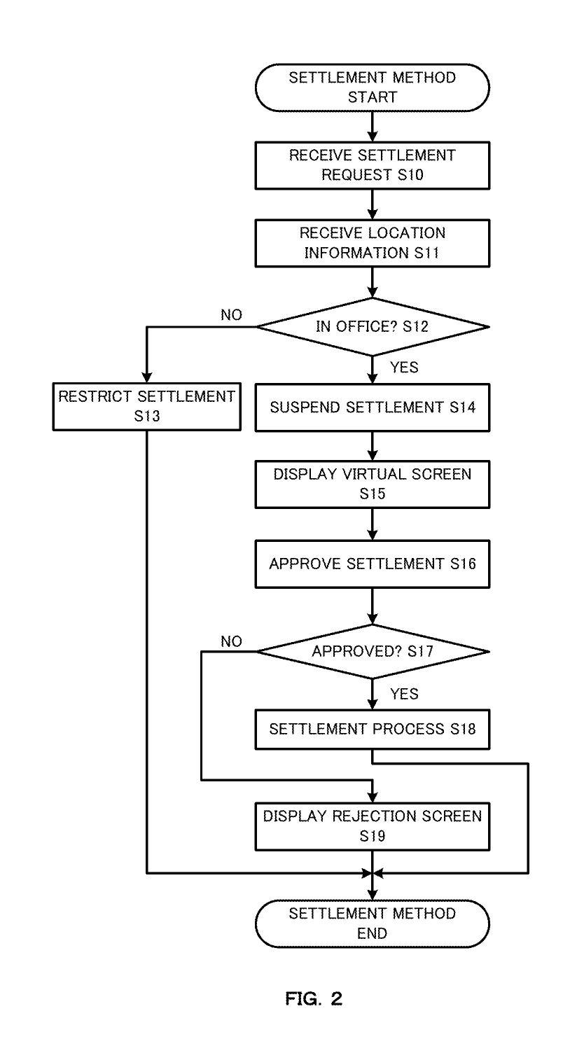

FIG. 2 shows a flow chart illustrating a method of credit-card settlement with approval flow that uses the settlement system 1. The tasks executed by the above-mentioned hardware and software modules will be described below.

### Step S10: Receive Credit-Card Settlement Request

First, the control unit 20 of the purchase web server 10 performs the receiving module 21 to receive a credit-card settlement request (step S10).

A purchaser who desiring to pay for office supplies, travel expenses, and accommodation fees on business with a credit card requests connection from the terminal 100A that the purchaser uses to the purchase web server 10. At this time, the purchaser inputs an ID and a password through the input unit 140A.

The control unit 20 refers to the ID management table 41 (FIG. 3) stored in the memory unit 40 to check whether or not the ID and the password that the purchaser input are correct. In the ID management table 41, an employee name and a password associated with an employee ID are previously registered. The control unit 20 checks whether or not the information transmitted from the terminal 100A matches that previously registered in the ID management table 41 so that the control unit 20 can check whether or not the information that the purchaser input is correct.

If the ID and the password are correct, the control unit 20 permits the terminal 100A to connect with the purchase web server 10.

Then, the purchaser pays for office supplies, travel expenses, and accommodation fees on business from a web page through the input unit 140A. At this time, the purchaser sets information on a purchase and an approval flow (including primary, secondary, and final approvers) through the input unit 140A. The control unit 20 sets information necessary for settlement application in the settlement application data table 42 (FIG. 4) stored in the memory unit 40 based on the information that the purchaser set.

The settlement application data table 42 is configured to set information including an application date, a purchase (including the place of purchase, item, unit price, amount, and amount of money), and an applicant ID, a primary, a secondary, and a final approver IDs to be associated with a processing number.

The purchaser inputs information on the credit card through the input unit 140A to request credit-card settlement. The control unit 20 refers to the credit card information table 43 (FIG. 5) stored in the memory unit 40 to check whether or not the credit card company, the card number, the expiration date, the password, and the security code that the purchaser input are correct. In the credit card information table 43, an employee name, a credit card company, a card number, an expiration date, a password, and a security code that are associated with an employee ID are previously registered. The control unit 20 checks whether or not the information transmitted from the terminal 100A matches that previously registered in the credit card information table 43 so that the control unit 20 can check whether or not the information that the purchaser input is correct.

If the information is correct, the control unit 20 checks whether or not the purchaser is in the office based on the location information.

### Step S11: Receive Location Information of Terminal 100A

The control unit 20 of the purchase web server 10 performs the receiving module 21 to receive the location information of the terminal 100A (step S11).

The purchaser transmits the current location information of the terminal 100A that the purchaser uses to the purchase web server 10. At this time, the terminal 100A transmits the location information of the terminal 100A that is acquired from GPS (Global Positioning System) and the service set identifier (hereinafter referred to as “SSID”) of the access point with which the terminal 100A connects as the current location information. The purchase web server 10 receives this current location information so that the purchase web server 10 can receive current location information of the terminal 100A.

### Step S12: Check Location Information

The control unit 20 of the purchase web server 10 checks whether or not the current location information of the terminal 100A is in the office (step S12) by referring to the location information or SSID of the office stored to the memory unit 40. If the check result is YES (the current location information is in the office), the control unit 20 passes processing to the step S14. If the check result is NO (the current location information is not in the office), the control unit 20 passes processing to the step S13.

The location information or SSID of the company is previously registered in the memory unit 40. The control unit 20 checks whether or not the current location information of the terminal 100A matches the location information or SSID that is previously registered in the memory unit 40 so that the control unit 20 can check whether or not the purchaser is in the office. The control unit 20 uses any one of or both of the location information and the SSID.

### Step S13: Restrict Settlement

If the check result is NO in the step S12, the control unit 20 of the purchase web server 10 performs the restriction module 24 to restrict the terminal 100A from performing the purchase settlement process even if receiving a settlement request in the step S10 (step S13). On the restriction of the purchase settlement process, the control unit 20 displays error notification on the terminal 100A and deletes the settlement without transmitting the settlement request received from the terminal 100A to the workflow server 50. The error notification screen is not limited in particular, for example, displays a message (e.g., “Not permitted outside of the office.”) from the administrator.

### Step S14: Suspend Settlement

If the check result is YES in the step S12, the control unit 20 of the purchase web server 10 performs the suspending module 22 to suspend the purchase settlement without making the settlement even if receiving the settlement request in the step S10 (step S14). Then, the control unit 20 transmits the data of the settlement application data table 42 to the workflow server 50 through the communication unit 30. The control unit 60 of the workflow server 50 stores the data of the settlement application data table 42 transmitted from the purchase web server 10 in the memory unit 80 as the settlement application data table 81.

### Step S15: Display Virtual Screen

The control unit 20 of the purchase web server 10 reads a predetermined program to achieve a virtual screen display module 31 in cooperation with the communication unit 30. The control unit 20 reads out the data on the virtual screen indicating that the settlement process has been completed based on the screen data 45 stored in the memory unit 40 and transmits the data on the virtual screen to the terminal 100A that transmitted the credit-card settlement request through the communication unit 30. The control unit 110A of the terminal 100A displays the virtual screen on the image display unit 150A based on the data on the virtual screen (step S15).

### Step S16: Approve Settlement

The control unit 60 of the workflow server 50 performs the approval module 61 to request the approval of the settlement from the approver in the approval flow (step S16).

First, the control unit 60 refers to the settlement application data table 81 stored in the memory unit 80 and sets information including a processing number, an applicant ID, and primary, secondary, and final approver IDs in the settlement approval data table 82 (FIG. 7).

The settlement approval data table 82 is configured to set information including an applicant ID and an approval status (approver's ID in each phase, approval or no approval) to be associated with a processing number.

The control unit 60 refers to the settlement application data table 81 stored in the memory unit 80 and transmits the existence of settlement to be approved and information necessary for approval to the terminal 100B that the primary approver uses. If the settlement is approved, the terminal 100B transmits the information indicating that the settlement to the workflow server 50. Then, the control unit 60 updates the primary approval status in the settlement approval data table 82 from “under application” to “approved” and the secondary approval status from “awaiting primary approval” to “under application” based on the information.

The control unit 60 refers to the settlement application data table 81 and transmits the existence of settlement to be approved and information necessary for approval to the terminal 100C that the secondary approver uses. If the settlement is approved, the terminal 100C transmits the information indicating that the settlement has been approved to the workflow server 50. Then, the control unit 60 updates the secondary approval status in the settlement approval data table 82 from “under application” to “approved” and the final approval status from “awaiting secondary approval” to “under application” based on the information.

The control unit 60 refers to the settlement application data table 81 and transmits the existence of settlement to be approved and information necessary for approval to the terminal 100D that the final approver uses. If the settlement is approved, the terminal 100D transmits the information indicating that the settlement has been approved to the workflow server 50. Then, the control unit 60 updates the final approval status in the settlement approval data table 82 from “under application” to “approved” based on the information.

By the way, there may be two or more items to be purchased through credit-card settlement. In this case, the control unit 60 may request the approvers' terminals 100B, 100C, and 100D to separately approve the two or more items and perform the settlement process on only approved items. This enables the rejection screen to less appear. Therefore, the present invention can provide a computer system with more excellent operational efficiency because the burden on the drafter (staff) and the useless cost for the company can be more reduced.

### Step S17: Check Approval

The control unit 60 of the workflow server 50 checks whether or not the settlement is approved based on the result of the step S16 (step S17). If the check result is YES (the settlement is approved), the control unit 60 passes processing to the step S18. If the check result is NO (the settlement is not approved), the control unit 60 passes processing to the step S19.

### Step S18: Perform Settlement Process

If the check result of the step S17 is YES, the control unit 60 of the workflow server 50 transmits information illustrating that the final approver approved the settlement to the purchase web server 10. The control unit 20 of the purchase web server 10 performs the processing module 23 to make the settlement suspended in the step S11 and update the settlement status in the settlement completion data table 44 (FIG. 6) stored in the memory unit 40 from “processing” to “completed” (step S18).

The settlement completion data table 44 is configured to set a settlement status to be associated with a processing number.

### Step S19: Display Rejection Screen

If the check result of the step S17 is NO, the control unit 60 of the workflow server 50 reads a predetermined program to perform the rejection screen display module 71 in cooperation with the communication unit 70. The control unit 60 reads out the data on the rejection screen indicating that the settlement has been rejected from the screen data 83 stored in the memory unit 80 and transmits the data on the rejection screen to the terminal 100A that requested the credit-card settlement through the communication unit 70. The control unit 110A of the terminal 100A displays the rejection screen on the image display unit 150A based on the data on the rejection screen (step S19).

The rejection screen is not limited in particular, for example, displays a message (e.g., “purchased last month.”) from the approver who rejected the settlement.

If the settlement is rejected, the credit-card settlement suspended in the step S14 may be deleted.

### Operation and Working-Effect of the Present Invention

According to the invention described in this embodiment, the operating of the restriction module 24 restricts the settlement when the terminal 100A is outside of the office even if the receiving module 21 receives a credit-card settlement request. On the other hand, if the terminal 100A is in the office, the corresponding process is performed based on the credit-card settlement request and other conditions.

Therefore, the present invention can provide a computer system that is capable to restrict the place where a drafter (staff) pays for office supplies, etc., consequently, restrict the purchase of office supplies, etc., outside of the office.

The operating of the suspending module 22 suspends credit-card settlement even if the receiving module 21 receives a credit-card settlement request. The operating of the approval module 61 requests an approver in the approval flow to approve the settlement. If the approver approves the settlement, the operating of the processing module 23 makes the settlement suspended by the operating of the suspending module 22.

Therefore, the present invention can provide a computer system that enables the drafter (staff) to perform the workflow to gain approval from the superior and make credit-card settlement to pay for office supplies, etc., at one time by only requesting credit-card settlement, consequently to gain more excellent operational efficiency.

Moreover, the operating of the virtual screen display module 31 shows the drafter (staff) the virtual screen indicating that the settlement process has been completed by only requesting a credit-card settlement. A series of processes of the workflow to gain approval from the superior and the credit-card settlement to pay for office supplies, etc., proceeds as a whole. In many cases in the course of business, unnecessary duplication of the drafter's effort to know the completion of credit-card settlement request and then to know that the superior approves the settlement several days later can be prevented. Therefore, the present invention can provide a computer system with more excellent operational efficiency because the burden on the drafter (staff) and the useless cost for the company can be more reduced.

Moreover, the operating of the rejection screen display module 71 allows the drafter (staff) to repeat the settlement request only when the rejection screen is displayed. Otherwise, extra burdens on request for credit-card settlement should not be considered. Therefore, the present invention can provide a computer system with more excellent operational efficiency because the burden on the drafter (staff) and the useless cost for the company can be more reduced.

Moreover, the receiving module 21 displays the screen to select an approval flow on the terminal 100A instructing settlement request and receives the selected approver according to the selection of the approval flow through the terminal 100A. This can minimize the number of the approvers according to the settlement request. Therefore, the present invention can provide a computer system with more excellent operational efficiency because the burden on the drafter (staff) and the useless cost for the company can be more reduced.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### REFERENCE SIGNS LIST

1 Settlement system
10 Purchase web server
50 Workflow server
100A Terminal

1. (canceled)

2. A computer system, comprising:
a check unit that checks whether or not the current location of a terminal is previously registered; and
a purchase restriction unit that restricts the terminal from performing a purchase settlement process if the current location of the terminal is not previously registered;
a receiving unit that receives a credit-card settlement request associated with an approval flow to make credit-card settlement on approval from an approver;
a suspending unit that suspends the settlement without making the settlement even if the receiving unit receives the settlement request;
an approval unit that requests an approver in the approval flow to approve the settlement; and
a processing unit that makes the settlement suspended by the suspending unit on approval from the approver.

3. The computer system according to claim 2, further comprising a virtual screen display unit that displays a virtual screen indicating that the process of the settlement has been completed on the terminal that instructed the settlement request when the receiving unit that receives a settlement request.

4. The computer system according to claim 2, further comprising a rejection screen display unit that displays that the process of the settlement was not performed on the terminal that instructed the settlement request when the approver does not approve the settlement.

5. The computer system according to claim 2, wherein the receiving unit displays a screen to select an approval flow on the terminal instructing settlement request and receives the selected approver according to the selection of the approval flow through the terminal.

6. A method for settlement, comprising the steps of:
checking whether or not the current location of a terminal is previously registered;
restricting the terminal from performing a purchase settlement process if the current location of the terminal is not previously registered;
receiving a credit-card settlement request associated with an approval flow to make credit-card settlement on approval from an approver;
suspending the settlement without making the settlement even if the receiving unit receives the settlement request;
requesting an approver in the approval flow to approve the settlement; and
making the settlement suspended by the suspending unit on approval from the approver.

7. A computer program product for use in a computer system, comprising a non-transitory computer usable medium having a set of instructions physically embodied therein, the set of instructions including computer readable program code, which when executed by the system causes an information processing unit to execute the steps of:
checking whether or not the current location of a terminal is previously registered;
restricting the terminal from performing a purchase settlement process if the current location of the terminal is not previously registered;
receiving a credit-card settlement request associated with an approval flow to make credit-card settlement on approval from an approver;
suspending the settlement without making the settlement even if the receiving unit receives the settlement request;
requesting an approver in the approval flow to approve the settlement; and
making the settlement suspended by the suspending unit on approval from the approver.
